(19) United States
(12) Patent Application Publication
(10) Pub. No.: US 2006/0085361 A1
(43) Pub. Date: Apr. 20, 2006

(54) Anomaly detector in a health care system using adapter

(75) Inventors: Dale E. Hoerle, Naperville, IL (US); Jeffery K. Hensley, Genoa, IL (US)

Correspondence Address: DALLAS OFFICE OF FULBRIGHT & JAWORSKI L.L.P., 2200 ROSS AVENUE, SUITE 2800, DALLAS, TX, 75201-2784, US

(73) Assignee: The TriZetto Group, Inc., Greenwood Village, CO (US)

(21) Appl. No.: 10/964,902

(22) Filed: Oct. 14, 2004

(51) Int. Cl. G06Q 99/00; G06Q 40/00

(52) U.S. Cl. 705/75; 705/44

(57) ABSTRACT

Disclosed are systems and methods which provide for monitoring an interface for software applications, for logging transactions conducted using the interface, and/or validating the transactions performed. Embodiments utilize adapters which communicate with an adapter monitor to determine the status of the adapters and/or interfaces provided using the adapters. A monitoring tool may additionally or alternatively be used to provide reporting with respect to the status of the adapters and/or interfaces provided using the adapters.

### CROSS-REFERENCE TO RELATED APPLICATIONS

The present invention is related to co-pending and commonly assigned U.S. patent applications Ser. No. [66729-P006US-10405929] entitled “INTERFACING DISPARATE SOFTWARE APPLICATIONS,” Ser. No. [66729-P012US-10405935] entitled “CENTRALIZED MANAGEMENT OF SOFTWARE ADAPTERS,” and Ser. No. [66729-P014US-10405937] entitled “SYSTEMS AND METHODS PROVIDING INTELLIGENT ROUTING OF DATA BETWEEN SOFTWARE SYSTEMS,” each of which is concurrently filed herewith and the disclosures of which are hereby incorporated herein by reference.

### TECHNICAL FIELD

The present invention relates generally to providing interfacing between software systems and, more particularly, to detecting and/or correcting anomalies in data associated with transactions between such software systems.

### BACKGROUND OF THE INVENTION

Enterprises, such as business enterprises, governmental enterprises, and private enterprises, often employ a number of systems (whether hardware, software, or combinations thereof) for providing functionality useful to the operation of the enterprise. For example, an enterprise may employ a complex computer network and communication system in order to facilitate information communication, processing, storage, analysis, modeling, etcetera. The aforementioned computer network may provide desired functionality through the use of various software systems, such as may comprise one or more software applications (referred to herein as applications) addressing particular aspects of the enterprise operations.

As but one example, for an enterprise providing healthcare services such applications may include a case management application, a credentialing application, a financial application, a membership management application, a commissions application, a customer service application, a provider network management application, a claims processing application, etcetera. Efficient operation of the enterprise may suggest that information from one or more such application should be exchanged (advantageously in real-time) with another one or more such application. However, each such application may utilize proprietary data formats, incompatible data inputs/outputs, or otherwise present barriers to their directly interfacing for desired information exchange making these applications not only disparate with respect to function but also disparate with respect to interfacing.

Further compounding the difficulties associated with the ability to provide information exchange between such an enterprise's applications, an enterprise may utilize more than one of any or all of the foregoing applications, wherein one or more applications providing a same or similar function may also be disparate. For example, a healthcare services enterprise may acquire or merge with another healthcare services enterprise, each having a number of systems, including different ones of the foregoing applications, for providing functionality useful to the operation of the enterprise. Thus, for example, an insurer (an example of a healthcare services enterprise) may comprise a plurality of disparate claims processing applications. Migration to one platform is likely to be costly and time consuming, thereby resulting in various legacy applications being used in parallel with other applications providing the same or similar functionality.

Approaches to providing integration between enterprise applications have included enterprise application integration (EAI) efforts which typically result in an EAI application uniquely tailored to a situation to provide interfacing between a plurality of specific enterprise applications. For example, an EAI application will typically be adapted to interface with particular enterprise applications and will provide a data path between particular ones of these applications (e.g., point-to-point interfacing). EAI applications have provided enterprise application interfacing in batch processing modes or in real-time processing modes, but heretofore have not offered a combination of batch processing and real-time processing.

EAI applications are generally a centralized application requiring considerable resources and manpower to operate and maintain. Although the software applications themselves often provide stable and reliable operation, EAI applications tend to be less stable and present reliability issues with respect to the application interfaces provided thereby failing or degrading. There has heretofore been no ability to monitor the performance of interfaces provided by EAI applications or to validate that they are working, without an operator actually monitoring the operation of the interfaces.

Moreover, EAI applications typically adopt a “stove pipe” configuration wherein they implement proprietary data interchange architecture and are adapted for use with only specific applications. If an enterprise, using a typical EAI application to provide interfacing between applications, changes, adds, or removes an application, the interface provided will be broken. Therefore, the EAI application will require corresponding modification, such as to add a new interface or modify an existing interface in order to support changes with respect to the enterprise applications. Such EAI application modifications are typically costly and-time consuming, resulting in a reluctance, or an inability, to implement enterprise application changes.

Accordingly, a need exists in the art for a software application interface which is more easily supported. A further need exists in the art for a software application interface which provides flexibility in the software applications supported. A further need exists in the art for a software application interface which provides for detecting and/or correcting anomalies in data associated with transactions between software applications.

### BRIEF SUMMARY OF THE INVENTION

The present invention is directed to systems and methods which provide for validating data associated with transactions conducted between various software applications. Embodiments of the invention provide an interface between software applications using multiple software modules (referred to herein as adapters). Preferably at least one adapter is associated with each end of a software application information communication link.

Adapters of a preferred embodiment of the present invention provide a decentralized architecture using a common communication bus protocol. For example, each adapter of an embodiment is adapted for proprietary data communication with one or more associated application, thereby providing information communication suitable for establishing an end of a software application information communication link. Additionally, each adapter of the foregoing embodiment is adapted for data communication with other adapters using protocols common to each such adapter. According to a preferred embodiment of the present invention, the common protocols utilized in inter-adapter communications comprise an open or standardized protocol, such as the extensible markup language (XML), simple object access protocol (SOAP), web services description language (WSDL), universal description, discovery and integration (UDDI), as a common communication bus protocol. For example, web services protocols, providing a standardized way of integrating web-based applications, may be used according to some embodiments of the invention.

Information communication provided between software applications using adapters of embodiments of the present invention may be provided in batch mode, in real-time mode, or in both batch and real-time modes. Real-time information communication may be provided by invoking requests or calls between adapters, and correspondingly between applications. For example, an embodiment of the present invention implements a web services module to facilitate an open architecture real-time information communication platform supporting calls between adapters. Batch information communication may be provided through publishing information by one or more adapter. For example, an adapter may monitor an associated software application for an event, such as a particular transaction or type of transaction, and after such an event is detected publish information regarding the event for other software applications to consume (via one or more adapter). The foregoing information may be published in a number of different ways according to embodiments of the present invention, such as to a database, to a message queue, to a flat file, etcetera. An application (or adapter associated therewith) requesting the information from another application can specify how the information is to be published, according to embodiments of the invention. Moreover, using adapters of the present invention, embodiments support various publication types, even though the application from which the information is published may not support the requested publication type (e.g., device type to which the information is published, format of the publication, the way in which the information is published, etcetera).

Adapters of embodiments of the invention are associated with or specifically designed for an enterprise function or “business process” basis, rather than having a one-to-one association with the applications for which interfacing is provided. For example, embodiments of the present invention provide adapters for use in healthcare services enterprises, such as may employ one or more case management application, credentialing application, financial application, membership management application, commissions application, customer service application, provider network management application, claims processing application, etcetera. However, rather than providing an adapter for each such application, embodiments of the present invention provide adapters for particular business processes or functions facilitated using one or more of the foregoing applications. For example, two or more adapters may be associated with a business process for payment adjudication, wherein this business process may involve various applications such as a financial application, commissions application, and claims processing application.

Adapters of embodiments of the present invention may be utilized in providing interfaces with respect to a plurality of applications providing a same or similar function. For example, adapters associated with a business process for payment adjudication may provide interfacing with respect to a plurality of claims processing applications, such as may include legacy systems as well as core systems.

A plurality of adapters may be utilized with respect to any particular software application according to embodiments of the invention. Likewise, a plurality of software applications may be associated with any particular adapter according to embodiments of the invention.

Using adapters of embodiments of the present invention, software applications may be changed, e.g., added, replaced, removed, etcetera, without affecting many of the information communication links. Additionally, such changed applications may be readily accommodated by providing an adapter or adapters configured for information communication with the changed application without changing other adapters used according to the present invention. The particular adapters affected by a changed application may include a plurality of adapters associated with business processes or functions provided by the changed application. To update an adapter to account for a change in the associated application, a programmer need only be familiar with the interface to the associated application and the generic format used with respect to the common communication bus. The programmer need not be familiar with the interface to other applications with which the associated application is to interface, or event the particular applications the associated application is to interface.

Adapters of embodiments of the invention provide information communication with modules or systems in addition to the aforementioned software applications and other adapters of an information communication interface. For example, adapters may provide information communication with an external agent module which provides operation and/or performance monitoring with respect to the agents. Such monitoring may be utilized to determine if the interface provided by corresponding agents is operational and performing to a desired level. Additionally or alternatively, such monitoring may be utilized to determine if individual adapters are operational and/or performing as desired. Likewise, adapters may provide information communication with logging modules, such as may compile a historical log of adapter operation, interface operation, information communication provided by interfaces, etcetera. Logs provided according embodiments of the present invention provide a record of transactions performed or attempted to be performed using an interface as described herein. Such transaction logs are particularly useful with respect to determining if a particular transaction has been properly completed as well as to determine if a particular transaction has already been performed.

According to an embodiment of the invention, adapters provide information communication with validation modules, such as may compile a validation database by receiving transactions flowing between software applications and applying those transactions to a set of data independent of the foregoing software applications. For example, transactions dealing with record management (e.g., adds, changes, deletes, etcetera) between the software applications are communicated by adapters of a preferred embodiment to a validation module, in addition to being communicated to appropriate ones of the other adapters/software applications, and the validation module applies the transactions to database records stored thereby. The validation module may later compare one or more database records in the validation database stored thereby with corresponding database records stored by various software applications to identify differences indicative of an anomaly in the communication between the software applications or in completion of the transaction by the software applications. Embodiments of the invention utilize logs in validating the transactions performed via an interface, such as by the validation process using data in a transaction log to determine what transaction, software application, processing batch, etcetera is associated with a particular anomalous database record. Using such log information, the source of a fault may be identified and/or the anomaly may be corrected (e.g., by rolling back transactions to a point before an anomalous transaction, reconducting an anomalous transaction, etcetera).

Validation of transactions and/or database records may be conducted at various times according to embodiments of the present invention. For example, a validation module may implement the above described validation operations periodically, such as every day, every week, every month, etcetera. Validation operations may be invoked with respect to particular transactions and/or database records according to different schedules. For example, particularly critical transactions or database records may be validated more frequently than less critical transactions. Validation operations according to embodiments of the present invention need not be periodic. For example, validation of particular database records may be invoked in response to an event, such as detecting a failure or impending failure of an adapter, determining that particular information was not consumed by one or more adapters, detecting that a particular transaction has been performed, etcetera.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 shows a high level block diagram of an enterprise system adapted for intra-application information communication according to an embodiment of the present invention; and

FIG. 2 shows additional detail with respect to an embodiment of adapters as shown in FIG. 1.

### DETAILED DESCRIPTION OF THE INVENTION

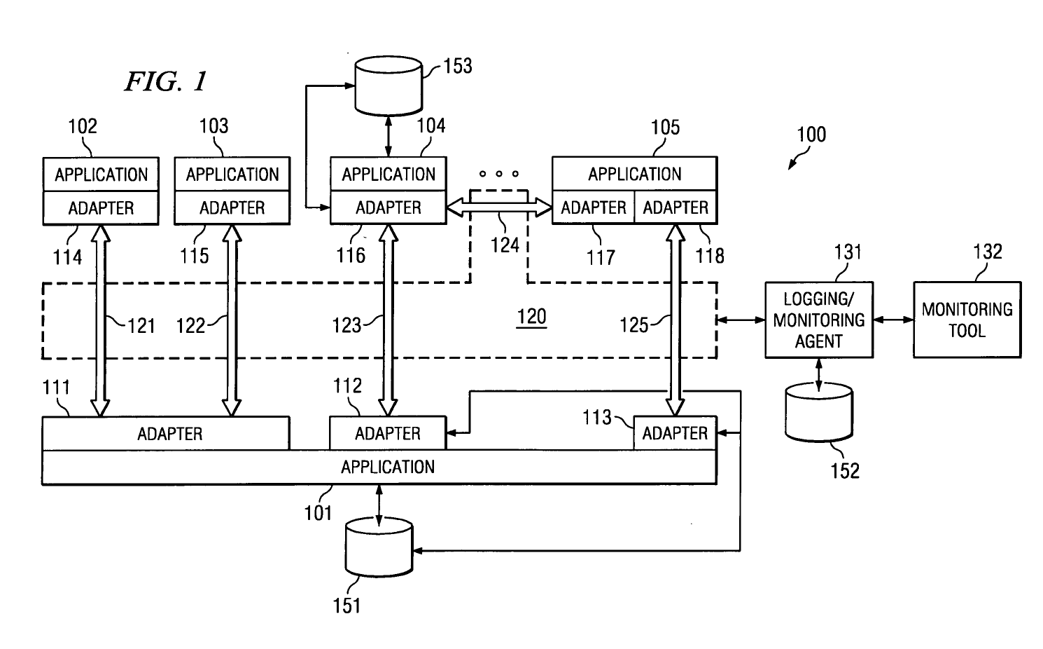

Directing attention to FIG. 1, a high level block diagram of enterprise system 100 in which interfaces are provided between disparate applications using a decentralized adapter architecture according to an embodiment of the present invention is shown. Enterprise system 100 of FIG. 1 includes a plurality of applications, shown here as applications 101-105. Applications 101-105 may provide various functions useful to the operation of an enterprise and may include multiple applications providing the same or similar functions, applications providing various aspects of particular functions, applications providing unrelated functions, etcetera. For example, where an enterprise associated with enterprise system 100 provides healthcare services, applications 101-105 may comprise one or more managed care payer administration application, case management application, credentialing application, financial application, etcetera. Applications 101-105 may utilize a number of different resources, such as database 151 associated with application 101 and database 153 associated with application 104, in providing the aforementioned functions.

Interfaces are provided between applications 101-105 according to the illustrated embodiment using adapters 111-118. As shown in FIG. 1, adapters 101-105 are associated with one or more information communication link, ones of which are illustrated as links 121-125, providing inter-application communication. Accordingly, a plurality of adapters and one or more links therebetween provide an interface between applications according to the illustrated embodiment. It should be appreciated, therefore, that an interface is not limited to a single link and corresponding adapters. Likewise, adapters are not limited to use with respect to a single link.

Adapters of embodiments of the present invention comprise instruction sets (e.g., software code) operable upon a processor based system. For example, an adapter of an embodiment of the present invention comprise one or more software modules operable upon a host system (e.g., server system) upon which an associated application is operable.

Adapters 111-118 of preferred embodiments are adapted to interact with one or more of applications 101-105 and therefore include logic for facilitating input and/or output of information from associated ones of applications 101-105. For example, each adapter of an embodiment is adapted for proprietary data communication with an associated application of applications 101-105,,thereby providing information communication suitable for establishing an end of an inter-application interface. Such proprietary data communication may include protocols, data formats, signaling, etcetera unique to interaction with the associated application. Additionally or alternatively, adapters 111-118 may be adapted to interact with resources of an associated application. For example, adapters of embodiments of the present invention interact with a database of an associated application, such as databases 151 and 153, to facilitate information communication between applications. Such interaction with these resources may be to obtain data for information communication, to determine a time and/or content of information communication, etcetera.

Each of adapters 111-118 of preferred embodiments are adapted to communicate with any of adapters 111-118. For example, each of links 121-125 of preferred embodiments implement a same or common information communication protocol, thereby providing common communication bus 120 facilitating communication between any and all of adapters 111-118. According to a preferred embodiment of the present invention, adapters 111-118 use an open or standardized protocol, such as XML, SOAP, WSDL, UDDI, etcetera, and combinations thereof, for the foregoing communications. For example, adapters 111-118 may use web services protocol, comprising a combination of XML, SOAP, WSDL, and UDDI, for inter-adapter communications.

It should be appreciated that common communication bus 120 of embodiments of the present invention may utilize any of a number of physical media for information communication. Where applications of enterprise system 100 are operable within a same host computer, for example, common communication bus 120 may utilize data busses of the computer system for information communication as described herein. As another example, where applications of enterprise system 100 are operable upon different host computers, common communication bus 120 may utilize network (e.g., local area network (LAN), metropolitan area network (MAN), wide area network (WAN), intranet, extranet, the Internet, public switched telephone network (PSTN), cable transmission, satellite) or other data links for information communication as described herein.

Common communication bus 120 of the illustrated embodiment facilitates creation of and modification to interfaces between applications 101-105. For example, because each of adapters 111-118 of embodiments are capable of communicating with any other of adapters 111-118 through common communication bus 120, new links may readily be added to or replace links 121-125 to provide a new or different interface. Likewise, adapters may be readily added to enterprise system 100 to provide new and different interfaces between an added adapter and one or more of adapters 111-118. Additionally or alternatively, when it becomes desirable to replace an adapter of adapters 111-118, such as when an application of applications 101-105 is changed or replaced, common communication bus 120 facilitates replacing such an adapter without the need to alter any other adapters or links of enterprise system 100.

Enterprise system 100 includes logging/monitoring agent 131 operable according to an embodiment of the present invention to communicate with one or more of adapters 111-118. Logging/monitoring agent 131 of embodiments includes one or more functional modules, such as an operation and/or performance monitoring module, logging module, and/or validation module, providing enhanced operation as described herein. For example, logging/monitoring agent 131 may communicate with each of adapters 111-118 via common communication bus 120 to monitor the operation of each such adapter, to monitor the status of interfaces provided by such adapters, to monitor the performance of interfaces, and/or the like. Logging/monitoring agent 131 may compile a historical log of adapter operation, interface operation, information communication provided by interfaces, and/or the like. Such information may be stored in a database, such as database 152, for analysis or later use. Such logs are particularly useful with respect to determining if a particular transaction has been properly completed as well as to determine if a particular transaction has been performed. Logging/monitoring agent 131 may compile and/or maintain a validation database and periodically validate data records associated with one or more software application to detect anomalies.

In operation according to a preferred embodiment, adapters 111-118 direct information communicated with other adapters and/or other information (e.g., status messages, operation metrics, performance metrics, etcetera) to logging/monitoring agent 131. Accordingly, logging/monitoring agent 131 may analyze information provided by particular adapters to determine that particular information was provided by a first adapter (e.g., transmitted to a particular adapter or adapters, published for consumption by an appropriate adapter or adapters, etcetera) and that this information was consumed by one or more second adapters.

Additionally or alternatively, adapters of some embodiments of the invention provide information to logging/monitoring agent 131 providing operational status and/or metrics. For example, an adapter may periodically provide a message to logging/monitoring agent 131 that the adapter is operating properly, such as when a predetermined period of time has elapsed in which the adapter has not otherwise provided logging or other information to logging/monitoring agent 131. An adapter may additionally or alternatively provide operational metrics, such as the length of time it took to perform a function, the number of messages in a queue to be serviced by the adapter, an average queue time, the number of transactions completed in a period of time, etcetera, to logging/monitoring agent 131. Logging/monitoring agent 131 may analyze such information to determine an operational status of an adapter (e.g., that the adapter is functioning, that the adapter's performance is degrading or improving, etcetera).

The foregoing status messages and/or status metrics may be generated by an adapter periodically, upon the occurrence of an event, in response to a message from an external source (such as logging/monitoring agent 131), and/or the like. According to one embodiment, an adapter implements a diagnostic routine, such as to confirm that an application interface and a communication interface are operable, to provide information for a status message. Similarly, an adapter of one embodiment implements a metric measurement routine, such as during the performance of particular functions, to provide information for a status metric.

Although embodiments have been described above with respect to an adapter autonomously providing information to logging/monitoring agent 131, it should be appreciated that such information may be provided in response to a query or polling. For example, logging/monitoring agent 131 may poll one or more of adapters 111-118 for such information.

Logging/monitoring agent 131 may provide information to monitoring tool 132, such as to apprise a system operator of current status and/or alarm conditions. For example, monitoring tool 132 may comprise a centralized console operating under control of a monitoring application, such as OPEN VIEW available from Hewlett Packard, Inc., adapted to cooperate with logging/monitoring agent 131 and providing information with respect to the status of interfaces and/or adapters of the present invention. Additionally or alternatively, monitoring tool 132 may provide information with respect to anomalies detected with respect to transactions and/or database records to an operator. According to one embodiment, if a comparison of validation database 252, or some portion thereof, with data associated with a software application detects an anomaly, monitoring tool 132, working in cooperation with logging/monitoring agent 131, may provide information with respect to a particular database having suspect data, a particular software application or applications likely to be responsible for the anomaly, a date or time of introduction of the anomaly into the data, a date or time before which no anomaly was present in the data, a particular transaction associated with the anomaly, and/or the like.

Monitoring tool 132 may receive reports and/or other signaling from adapters 111-118, and/or from logging/monitoring agent 131 to provide a status report to an operator. For example, when no communication activity has been performed by an adapter for a predetermined period of time (and thus no transaction logging data or other signaling has been provided by the adapter to the logging/monitoring agent for a period of time), monitoring tool 132 and/or logging/monitoring agent 131 may query the adapter to determine the operational status of the adapter. Additionally or alternatively, the adapter may provide such signaling spontaneously, such as after a predetermined amount of time, if desired.

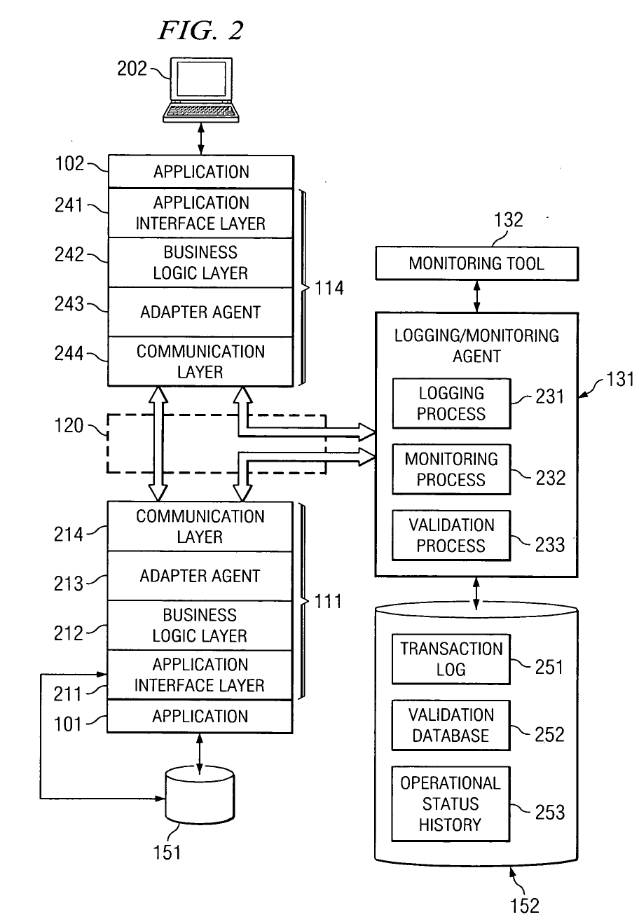

FIG. 2 shows additional detail with respect to adapters utilized in providing an interface between applications according to an embodiment of the present invention. Specifically, detail with respect to adapters 111 and 114, providing an interface between applications 101 and 102, of FIG. 1 are shown in FIG. 2.

As can be seen in the exemplary configuration of FIG. 2, adapters of embodiments of the present invention comprise a layered configuration. Specifically, in the illustrated embodiment adapter 111 comprises layers 211-214 and adapter 114 comprises layers 241-244, corresponding to an application interface layer, a business logic layer, an adapter agent layer, and a communication layer, respectively, interacting to provide functionality as described herein. Alternative embodiments of the invention may include more or fewer layers (including a single layer), and layers thereof may provide functionality in addition to or in the alternative to that described with respect to the illustrated embodiment.

An application interface layer, e.g., application interface layers 211 and 241, of embodiments provides arbitration between an associated application's proprietary input/output format and data structure and a data structure of the common communication bus. For example, application interface layer 211 may facilitate interaction with application 101 to identify particular information within the application, to input and/or extract appropriate information, and to convert information between a proprietary format of application 101 and a format of common communication bus 120. Application interface layer 211 may input and/or extract the foregoing information from resources of application 111, such as database 151, in addition to or in the alternative to interacting directly application 111, if desired.

A business logic layer, e.g., business logic layers 212 and 242, of embodiments provides arbitration of particular business processes into objects for fulfilling functions supported by adapters of embodiments of the present invention. Adapters of embodiments of the invention are associated with an enterprise function or “business process.” Accordingly, embodiments of the present invention provide adapters 111-118 for particular business processes or functions facilitated using one or more of applications 101-105. A particular business process may implicate particular information associated with a plurality of applications. A business logic layer of embodiments of the present invention will identify the information implicated, the applications associated with the information, and steps or a process used to implement the business process as between the plurality of applications to appropriately exchange information using the aforementioned objects. In operation, a business logic layer of a preferred embodiment receives data in a standard format (either from an application via an application interface layer or from another adapter via a communication layer), determines what part of that data is to be ignored and which part of that data is to be used for the business process as implicates the interface provided, transforms that portion of data as suitable for providing to an application or another adapter to accomplish the business process.

Business logic layers of embodiments of the invention may additionally provide routing information, such as to indicate that an information object is to be published and/or to identify one or more adapters or applications to which information objects are to be communicated. Routing information may be determined based upon various criteria, such as the information content, the business process being performed, the particular function, etcetera. Such routing information may identify adapters and/or applications by a class, type, or a function performed. Alternatively, such routing information may specifically identify a particular adapter or application. Preferred embodiments, however, implement an information object routing technique which does not rely upon identification of particular adapters or applications to which such information is to be routed. For example, business logic of adapters of preferred embodiments is self aware of the functions supported thereby and thus may consume information objects having an associated function object for which functions are supported by the adapter.

The objects utilized by business logic layers of an embodiment are preferably standardized to facilitate predictable interaction between adapters. Objects utilized according to embodiments of the invention define the type of information that the adapter will be transforming, types of methods that the adapter will perform, etcetera. For example, an information object may be defined as “member” having an information structure including information for a member (e.g., name, address, phone number, account number, etcetera) stored by an associated application. Similarly, an information object may be defined as “transaction” having an information structure which includes information for a transaction (e.g., member name, service provider, date of services, type of services, etcetera) stored by an associated application. Additionally, a function object may be defined as “delete” which includes steps associated with a record deletion in an associated application.

Although any number and type of objects may be utilized according to embodiments of the invention, objects used are preferably shared among adapters. For example, each adapter associated with applications for which member information is stored may implement a “member” information object, although the actual information (in content and the fields included in the structure) may vary from application to application. Likewise, each adapter associated with applications for which particular functions (e.g., delete, add, update, final, etcetera) are to be invoked have a corresponding function object, although the particular steps performed by the function objects may vary from application to application. Accordingly, objects of preferred embodiments operate to convert information between a generic information structure and a structure utilized by a business process in a particular application (information objects) and to convert generic functions to functions utilized by a business process of a particular application (function objects). In view of the above, the data and the functions (e.g., delete, add, etcetera) are transformed between an application-specific format to a generic format. Further, the functions (business logic) to be implemented in a given adapter may be selected on a per business process (or “business cycle”) basis, as described further herein.

In operation according to embodiments of the invention, business logic layer 212 transforms requests and other outputs of application 101, provided in a standardized format by application interface layer 211, into standardized objects understandable to other adapters, such as to satisfy a request or otherwise appropriately consume the output. Similarly, business logic layer 212 transforms responses and other inputs to application 101, provided in a standardized format by a corresponding interface layer (e.g., interface layer 241) and/or as a standardized object by a corresponding business logic layer (e.g., business logic layer 242), into information in the appropriate format understandable to application 101, such as to provide a response to a previous request or otherwise appropriately use the input.

Adapters of embodiments of the invention are associated with an enterprise function or “business process.” Accordingly, embodiments of the present invention provide adapters 111-118 for particular business processes or functions facilitated using one or more of applications 101-105. A particular business process may implicate particular information associated with a plurality of applications. A business logic layer of embodiments of the present invention will identify the information implicated, the applications associated with the information, and steps or a process used to implement the business process as between the plurality of applications to appropriately exchange information using the aforementioned objects. In operation, a business logic layer of a preferred embodiment receives data in a standard format (either from an application via an application interface layer or from another adapter via a communication layer), determines what part of that data is to be ignored and which part of that data is to be used for the business process as implicates the interface provided, transforms that portion of data as suitable for providing to an application or another adapter to accomplish the business process.

The foregoing business processes may be of various scales. For example, adapters of embodiments of the present invention may be associated with business processes on a small or micro-scale, such as may include processes associated with a single data record, individual, transaction, or event. Micro-scale business processes of one embodiment include relatively simple processes such as add a new patient, add a new provider, change an address, query an individual's information, post a payment to an account, retrieve detail for a particular claim, and the like. Adapters of embodiments of the present invention may additionally or alternatively be associated with business processes on a large or macro-scale, such as may include processes associated with multiple data records, individuals, transactions, or events. Macro-scale business processes of one embodiment include relatively complex processes such as process claims, adjudicate claims, period end processing, import data, global updates, and the like.

The illustrated embodiment of FIG. 2 includes an adapter agent layer, e.g., adapter agent layers 213 and 243. Adapter agent layers of preferred embodiments facilitate monitoring and/or transaction logging. For example, an external logging/monitoring agent, such as logging/monitoring agent 131 of FIG. 1, may communicate with adapter agent layers of each adapter validate that each such adapter is operating as well as to monitor transactions performed by the adapters. Preferred embodiment adapter agent layers are disposed above the aforementioned business logic layer to facilitate transaction logging, such as through monitoring particular objects communicated by or consumed by an associated adapter. Additionally, preferred embodiment adapter agent layers are disposed below a communication layer to facilitate monitoring of the performance of interface provided by an associated adapter to validate that the interface is working and/or to monitor performance metrics associated with its operation. An adapter agent layer may be omitted from embodiments wherein monitoring and/or transaction logging is not desired.

In operation according to a preferred embodiment, adapter agent layers direct a copy of each object passed between a business logic layer and communication layer to a logging/monitoring agent. Accordingly, the logging/monitoring agent may analyze the objects provided by particular adapters to determine that particular information was provided by a first adapter (e.g., transmitted to a particular adapter or adapters, published for consumption by an appropriate adapter or adapters, etcetera) and that this information was consumed by one or more second adapters.

Alternatively, adapter agent layers may direct a subset of the information passed between a business logic layer and communication layer to a logging/monitoring agent. For example, an adapter agent layer may analyze objects passed between an associated business logic layer and communication layer in order to determine appropriate objects for forwarding to a logging/monitoring agent, such as objects associated with particular processes (e.g., mission critical processes, particular processes to be validated, processes associated with particular applications, etcetera), objects containing particular information (e.g., mission critical information, information to be validated, information utilized by particular applications, etcetera), and/or the like. Directing a subset of the information to a logging/monitoring agent may be desirable in situations where bandwidth associated with common communication bus 120 is limited or where it is otherwise desired to minimize the amount of information communication over communication links.

Although the foregoing embodiments have been discussed with respect to an adapter agent layer directing communications to a logging/monitoring agent, embodiments of the present invention may provide logging and/or monitoring without an adapter agent layer providing such routing functions. For example, a communication layer as described below may provide routing of objects. Additionally or alternatively, a communication layer may publish each object, or particular objects identified by an adapter agent layer, to a database or other resource available to a logging/monitoring agent according to embodiments of the invention.

It should be appreciated that communication between adapter agent layers and logging/monitoring agents of embodiments of the invention may be provided directly through a communication interface of the adapter agent layers. However, a preferred embodiment of the invention utilizes the communication interface provided by the communication layer, discussed below, in providing communication between an adapter agent layer and a logging/monitoring agent. Accordingly, resources provided by such a communication layer may be optimally utilized and duplication of such resources may be avoided. Moreover, the foregoing logging/monitoring agents may be readily adapted for communication with any number of adapters using a common communication bus, as described above.

A communication layer, e.g., communication layers 214 and 244, of embodiments provides for communication with other adapters. Communication provided by the communication layers of preferred embodiments is in a same or common information communication protocol to provide a common communication bus, such as common communication bus 120 of FIG. 1. The foregoing common information communication protocol may be provided using a web services architecture. It should be appreciated that adding new or modified adapters to an enterprise system using adapters having a communication layer as illustrated, providing a common communication bus, is simplified due to each adapter communicating via the common communication bus. Accordingly, adapters may be readily added as new applications are added/changed and/or as business processes are added/changed.

Communication layers of embodiments of the invention may provide inter-adapter communication in a number of ways. For example, communication may be provided in real-time to establish a real-time interface between applications, such as may be useful in low-latency or no latency (e.g., interactive) processing of transactions or queries which involve multiple applications. Additionally or alternatively, communication may be provided in batch to establish a periodic interface between applications, such as may be useful in accumulated or high-volume processing of transactions or records which involve multiple applications.

Embodiments of the present invention employ communication layers which support various communication paradigms. For example, communication layers may implement a web services architecture to provide communication in response to requests (e.g., a request as issued by an associated application or adapter) and responses (e.g., a response to a previous request as issued by an associated application or adapter). Additionally or alternatively, communication layers may implement a publishing or messaging services architecture to push information to one or more destinations, such as upon the occurrence of an event, periodically, or based upon other triggers. Such information may be published directly to one or more consuming adapters or the information may be published to a data store, such as database 152 of FIG. 1, accessible to one or more consuming adapters.

Having described the layers of a preferred embodiment adapter, their use with respect to an exemplary interface will be described. To provide an example of operation of adapters according to an embodiment of the present invention, it will be assumed that application 102 comprises a claim system, that application 101 comprises a case management system, and, as but one example business process which may be provided an inter-application interface according to the present invention, that a user at terminal 202 has added a new member to the claim system of application 102. For example, the user may have input a new member's name, address, age, telephone number, weight, height, etcetera through a user interface of application 102. The user may desire that corresponding new member records be created in one or more other applications of enterprise system 100. Accordingly, an inter-application interface of embodiments of the present invention is invoked to provide the proper information to appropriate applications, such as application 101, as well as to perform the appropriate functions to achieve creation of the new record and populate the appropriate fields with information.

Adapter 114, associated with application 102 wherein the user has created the new member record, operates to provide information to a corresponding adapter, such as adapter 111 associated with application 101. For example, application interface layer 241 under control of business logic layer 242 may monitor a resource associated with application 102, such as a database (not shown), to recognize that an event associated with the business process for which adapter 114 is responsible has transpired (e.g., the appearance of a new member record). Additionally or alternatively, application interface layer 241 may monitor output of application 102 to determine that inter-application communications are to be conducted. For example, application 102 may output new member information, perhaps under control of the user, for creating corresponding records in other applications. Although application 102 may have the capability to output information for updating other applications, application 102 of the illustrated embodiment does not possess the ability to provide the information in the appropriate format, is unaware of which other applications are to receive the corresponding update, and does not know the particular functions to invoke to achieve an appropriate update by such applications. Accordingly, adapters of embodiments of the present invention provide such functionality.

Having determined that an event has transpired, or otherwise having determined that inter-application communications are to be performed, application interface layer 241 obtains the appropriate information from application 102 and/or its associated resources and converts the information to a generic format of common communication bus 120. For example, application interface layer may cooperate with business logic layer to identify the particular information available from application 102 and/or its associated resources for use in an associated business process. The identified information may be obtained by application interface layer 241 and converted to a format of common communication bus 120 for forming an information object by business logic layer. According to a preferred embodiment, the information obtained by application interface layer 241 and placed into an information object by business logic layer 242 comprises all the information from application 102 associated with the business process. For example, in the add member example, the new member's name, address, age, telephone number, weight, height, etcetera may be obtained, although one or more consuming application may use only a portion of this information. Accordingly, the information object created is adapted to be utilized by a number of different applications (including applications which are later modified or added) without modification to adapter 114.

Business logic layer 242, in addition to cooperating with application interface layer 241 to identify information to be obtained and placing the information into an information object, operates to determine what function objects are to be associated with the information for facilitating the business process at an interfaced application. In the new member example, business logic layer 242 may associate an “add” function object with the information object. Business logic layer 242 of a preferred embodiment identifies corresponding applications or their interfaces to which the objects apply, such as by indicating a business process the information object (or objects) and function object (or objects) is to accomplish. Although the present example is described with respect to providing new member information to application 101 comprising a case management system, it should be appreciated that the foregoing objects may be provided to any number of applications (including multiple iterations of the same application, multiple applications providing the same or similar functionality, multiple applications consuming the same information, etcetera). All the foregoing information may be passed to communication layer 244 for communication via common communication bus 120 to adapter 111.

The illustrated embodiment includes adapter agent 243 disposed between business logic layer 242 and communication layer 244. Adapter agent layer 243 monitors objects passed between business logic layer 242 and communication layer 244 and provides a copy of these objects to logging/monitoring agent 131. Logging/monitoring agent 131 of one embodiment stores a copy of the objects, or information contained in the objects, in database 152.

For example, transaction log 251 may store information such as temporal information (e.g., date and/or time of transmission of the objects), identification information (e.g., identification of a transmitting application/adapter and/or identification of a receiving application/adapter), transaction information (e.g., a business process and/or function associated with the objects), operational information (e.g., associated performance, transmission, and/or processing metrics), etcetera useful in logging transactions, logging communications, or otherwise logging interaction between the various software applications. Additionally or alternatively, transaction log 251 may comprise a copy of objects, or information contained therein, provided to logging/monitoring agent 131. Such information or objects may comprise information associated with each object or selected ones of the objects, such as the information objects, information associated with objects used with particular functions, information associated with objects transmitted by particular adapters, information associated with objects received by particular adapters, etcetera. Accordingly, transaction log 251 may be used to compile a historical log of adapter operation, interface operation, information communication provided by interfaces, etcetera. Such transaction logs are particularly useful with respect to determining if a particular transaction has been properly completed as well as to determine if a particular transaction has already been performed.

Additionally or alternatively, validation database 252 may store information useful with respect to validation of transactions performed using application interfaces as described herein. For example, validation database 252 may comprise data fields corresponding to those of one or more software applications of an enterprise system for which interfacing is provided according to an embodiment of the present invention. A validation module of logging/monitoring agent 131 may receive a copy of objects, or information contained therein, from one or more adapters and utilize the objects or information to manipulate data of validation database 252 in accordance with data manipulation in a database of an application using the object (e.g., add, delete, modify, etcetera). Accordingly, validation database 252 of a preferred embodiment provides an independent database reflecting a current state of data. Validation database 252 may comprise additional information, such as temporal information (e.g., date and/or time of the transaction and/or validation), identification information (e.g., identification of a transmitting application/adapter and/or identification of a receiving application/adapter), transaction information (e.g., a business process and/or function associated with the transaction), etcetera. Accordingly, validation database 252 may be used to verify that a particular function of a transaction has been properly and/or completely executed with respect to one or more application and to identify adapters, application interfaces, and/or applications for which validation has failed.

Using information identifying corresponding applications or their interfaces provided by business logic layer 242, communication layer 244 communicates the information objects and function objects to appropriate destinations. For example, where the information is not real-time, communication layer 244 may publish the objects directly to adapter 111 or a published information database for later retrieval by adapter 111. Where the information is real-time, communication layer 244 preferably communicates the objects directly to adapter 111 for real-time updating of the case management system of this example. Additionally or alternatively, communication layer 244 may place the information objects and function objects on common communication bus 120 for the appropriate adapters to recognize this information as being relevant to their functions and consume the .information accordingly.

The layers of adapter 111 essentially work in the reverse of that described above with respect to the layers of adapter 114. For example, communication layer 214 obtains the objects communicated by communication layer 244, such as directly from communication layer 244 or from a published information database. Business logic layer 212 of an embodiment analyzes the function objects to determine what business operation is to be performed and uses its business logic to determine the steps associated with the business operation as well as the particular information within the information objects relevant to application 101 in this business operation. Application interface layer 211 converts the information and the function steps into the format and steps specific to accomplishing adding the new member to application 151. The information may be provided to application 101 and/or directly to one or more resources of application 101, such as database 151, by application interface layer 211.

As with adapter agent 243 discussed above, adapter agent 213 is disposed between business logic layer 212 and communication layer 214. Adapter agent layer 213 may monitor objects passed between business logic layer 212 and communication layer 214 to provide the ability to monitor the performance of an interface provided by the adapters, to provide transaction logging, and/or to validate that the is working. For example, adapter agent 213 may provide information with respect to objects passed between business logic layer 212 and communication layer 214 to logging/monitoring agent 131.

Although adding a member of this example has been described with reference to information flowing from application 102 to application 101, it should be appreciated that such information may flow bi-directionally as well as uni-directionally. For example, application 101 may provide responsive information which passes through the layers of adapter 111 and adapter 114 to application 102. Similarly, adapter 111 may provide responsive information to adapter 114, such as to confirm the update, to request additional information, etcetera.

Although operation of logging/monitoring agent 131 has been described in the above example as receiving objects, and perhaps other information, from adapters during inter-adapter communication, communication between logging/monitoring agent 131 and adapters of embodiments of the present. invention is not limited to the exemplary communications. One or more adapter may provide information, messages, or other signaling to logging/monitoring agent 131 periodically, at various times, in response to events, etcetera. For example, an adapter may provide a message to logging/monitoring agent 131 when the agent is brought on-line, or otherwise initialized, such as to make logging/monitoring agent 131 aware of the agent or to facilitate logging of initialization times. Additionally or alternatively, an adapter may provide a periodic message to logging/monitoring agent 131 indicating that the adapter is operational, such as when a predetermined period of time has transpired since a last communication with logging/monitoring agent 131 or after an internal diagnostic routine has successfully completed. Adapters of embodiments of the invention may provide a message to logging/monitoring agent 131 upon the occurrence of an event, such as when a business process cannot be completed properly (e.g., due to an associated adapter or application failing), when a monitored threshold has been traversed (e.g., when a message queue time is exceeded, when a performance metric is excessively low, when a timeout for a process has occurred, etcetera). In addition to or in the alternative to an adapter providing such information, messages, or signaling to logging/monitoring agent 131, logging/monitoring agent 131 of embodiments of the invention may poll or query any or all the foregoing from one or more adapter.

Logging/monitoring agent 131 of embodiments of the invention provide monitoring of the performance of an interface provided by the adapters, provide transaction logging, and/or validate the transactions performed by adapters. Accordingly, the illustrated embodiment of logging/monitoring agent 131 includes logging process 231, monitoring process 232, and validation process 233, as may cooperate with one or more of transaction log 251, validation database 252, and operational status history 253.

According to an embodiment of the invention, logging process 231 obtains objects handled by adapters 111-118 and causes those objects, or information contained therein, to be stored in transaction log 251. Logging process 231 may store additional information associated with the objects in transaction log 251, such as time-stamps, identification of a transmitting and/or receiving adapter, information with respect to the business process the object is associated with, etcetera. Such information may be particularly useful in later analysis of operation of the adapters, the applications, and/or the common communication bus.

Logging process 231 may provide substantially passive storage of the above mentioned information, i.e., obtaining and storing the information without analysis or communication with other processes performing analysis. However, embodiments of the present invention provide a logging process which provides some active analysis of the information, or cooperates with processes which provide active analysis of the information. For example, an embodiment of logging process 231 may analyze the objects to determine that a particular adapter has not provided an object or other information for transaction logging for some period of time. This information may be used by logging process 231 to notify another process, such as monitoring process 232 and/or validation process 233, for taking some action. Additionally or alternatively, this information may be used by logging process 231 to perform additional processing, such as to query the identified adapter, to generate an entry in transaction log 251, to cause an alarm at monitoring tool 232, etcetera.

According to an embodiment of the invention, monitoring process 232 monitors adapters 111-118 to determine their operational status and/or performance metrics. For example, monitoring process 232 may receive (or poll) periodic messages from adapters stating that they are “alive.” Additionally or alternatively, monitoring process 232 may cooperate with other processes, such as logging process 231, to determine the operational state of adapters, such as by the fact that they are actively transmitting/consuming objects. Accordingly, monitoring process 232 may monitor adapters directly and/or indirectly.

Monitoring process 232 of embodiments of the invention provides monitoring and analysis beyond determining that individual adapters are operational. For example, monitoring process 232 may analyze combinations of adapters, such as those associated with a particular business process or particular applications, to determine that an inter-application interface provided by the adapters is operational. Moreover, such analysis may include performance metric determination and/or analysis. For example, monitoring process 232 may analyze queue time information, information with respect to objects transmitted and received, etcetera provided by adapters to determine the operating efficiency of adapters and/or application interfaces. This information may be stored in a database, such as operational status history 253, for comparison with metrics determined at a later time. Such comparisons may be particularly useful in determining eminent failure of an adapter or application interface as these tend to fail over a period of time.

Validation process 233 of embodiments of the invention provides validation of transactions performed via an application interface. In operation according to a preferred embodiment, validation process 233 receives transactions (e.g., adds, changes, deletes, etcetera) that are flowing through interfaces between software applications and applies those transactions to validation database 252.

Interfacing with an application by validation process 233 may utilize one or more of adapters 111-118. However, a preferred embodiment provides a validation process 233 which establishes an interface independent of the adapter used in with respect to the transaction being verified, such as by using another suitable adapter or by validation process 233 directly interfacing with the application and/or its resources, to prevent a validation error associated with the adapter.

Validation database 252 may initially be established through operation of validation process 233 interfacing with software applications and/or their associated databases, such as through the aforementioned adapters, to obtain information with respect to the data used thereby, the particular data structures of data fields, the actual data, etcetera. This information is utilized by validation process 233 according to embodiments of the invention to create appropriate data fields and populate those data fields with current data. Thereafter, this data is updated using the aforementioned objects provided to validation process 233. As software applications are added or removed from the enterprise system, validation process 233 may again interface with software applications and/or their associated databases to remove any unused data fields and/or add any additional data fields associated with the removed/added software applications.

Validation database 252 may comprise data fields corresponding to each data field used by applications 101-105. For example, if application 101 includes a name field (e.g., designated as Full_Name in the data structure of application 101) and a birth date field (e.g., designated as Birth_Date in the data structure of application 101) and application 102 includes a personal identification number field (e.g., designated as PIN in the data structure of application 102) and a birth date field (e.g., designated as DOB in the data structure of application 102), validation database 252 may include a name field corresponding to the name field of application 101, a birth data field corresponding to the birth date fields of applications 101 and 102, and a personal identification number field corresponding to the personal identification number field of application 102.

It should be appreciated that the field designators utilized by validation database 252 need not be the same as any or all field designators used by the software applications. However, a mapping of the fields utilized by validation database 252 to the corresponding fields of the software applications is preferably established, such as within a validation module of logging/monitoring agent 131. Accordingly, modification of a data field of validation database 252 may be made in accordance with a transaction affecting a corresponding data field of a software application. Likewise, data stored within data fields of validation database 252 may be compared to data stored within data fields of a software application to validate the data.

Although embodiments of the invention provide a validation database which includes data fields corresponding to all data fields of software applications provided the above described interface, alternative embodiments of the invention provide a validation database which includes data fields corresponding to some subset of data fields of software applications provided an interface. For example, data fields associated with mission critical data, data particularly susceptible to errors or desynchronization between the various software applications, data which is often the subject of inter-application transactions, and/or the like may be selected for inclusion in a validation database of an embodiment of the present invention.

Validation process 233 may analyze particular transactions in transaction log 251 to determine information which was to have been altered with respect to a particular application. Validation process 233 may then interface with that application and/or resources associated with that application to verify that the information reflected in the application matches that of validation database 252. For example, an entry in transaction log 251 may indicate that application 101 (a case management system in the above example) was to have a new member added (via an interface with application 102, a claim system in the above example). Validation process 233 may compare data in particular fields of validation database 252 and a database associated with application 101 to verify not only that the process of inputting the information from application 102 was accomplished, but that the information was input correctly (e.g., first name appears in a first name field, last name appears in a last name field, etcetera). Information with respect to validation, such as identification of transactions and/or applications which have been validated, identification of transactions and/or applications for which validation failed, identification of adapters, application interfaces, and/or business processes associated with failed validations, etcetera may be stored in validation database 252 or in a separate validation log (not shown), if desired. Validation of data according to the foregoing is particularly useful in detecting if transactions have been completed correctly and detecting if data is mis-mapped between the various software applications.

If an anomaly is detected, transaction log 251 and/or a validation log may be referenced to identify a potential source of the anomaly. For example, transaction log 251 may be referenced to identify the application and adapters utilized in providing the errant data. Similarly, transaction log 251 may be referenced to determine a time of the transaction, a particular business process associated with the data having been altered, other data which may have been altered with or because of the errant data, etcetera. A validation log, such as may be kept as part of validation database 252, may be referenced to determine a last time the errant data was validated as correct, such as to provide a point to which the software application database should be rolled back to. This information may be used to report to an operator, such as via monitoring tool 132. Additionally or alternatively, this information may be utilized to re-run one or more transaction, such as may be identified from transaction log 251, in order to cause data fields to properly synchronize.

Logging/monitoring agent 131 of embodiments of the invention interacts with monitoring tool 132 to provide information with respect to the application interfaces provided by adapters of the present invention to a system operator or other party. For example, monitoring process 232 may provide operational metrics to monitoring tool 132 to display (e.g., graphically and/or textually) application interface status in real-time to a system operator. Similarly, validation process 232 may provide information with respect failed validations to monitoring tool 132 in order to notify a system operator in real-time. Notification to a system operator as provided by monitoring tool 132 may comprise display upon a control console, sounding an audible alarm, placing one or more telephone calls (e.g., to an office phone, a home phone, a cell phone, etcetera), transmitting one or more messages (e.g., an e-mail message, a short message service (SMS) message, a text message, etcetera), and the like.

Although the present invention and its advantages have been described in detail, it should be understood that various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A method comprising:
providing a copy of transaction information communicated in an interface between a first application program and a second application program to a validation process; and
updating, by said validation process, a validation database in accordance with said transaction information.

2. The method of claim 1, wherein said interface between said first application program and said second application program is provided using at least one adapter, wherein said providing a copy of said transaction information comprises:
detecting said transaction information as said transaction information passes through said at least one adapter; and
routing a copy of said transaction information to said validation process.

3. The method of claim 1, wherein said providing a copy of said transaction information comprises:
providing a copy of information associated with each transaction implemented between said first application program and said second application program using said interface.

4. The method of claim 1, wherein said providing a copy of said transaction information comprises:
providing a copy of selected information associated with transactions implemented between said first application program and said second application program using said interface.

5. The method of claim 1, wherein said providing a copy of said transaction information comprises:
providing a copy of information associated with selected transactions implemented between said first application program and said second application program using said interface.

6. The method of claim 1, further comprising:
verifying data associated with at least one of said first application program and said second application program using said validation database.

7. The method of claim 6, wherein said verifying data comprises:
comparing data of a data field of said validation database corresponding to a data field of a database associated with said at least one of said first application program and said second application program.

8. The method of claim 6, further comprising:
performing said verifying data periodically.

9. The method of claim 8, wherein a periodicity of said performing said verifying data is a function of the data verified.

10. The method of claim 6, further comprising:
performing said verifying data in response to an event.

11. The method of claim 10, wherein said event comprises having conducted a particular transaction.

12. The method of claim 10, wherein said event comprises at least a portion of said interface showing performance degradation.

13. The method of claim 10, wherein said event comprises at least a portion of said interface having failed.

14. The method of claim 6, further comprising:
reporting anomalies with respect to said data associated with at least one of said first application program and said second application program.

15. The method of claim 1, further comprising:
mapping data fields of said validation database to data fields of databases associated with said first application program and said second application program.

16. The method of claim 15, wherein said mapping data fields comprises:
mapping at least one data field to a data field of a database associated with said first application program and a data field of a database associated with said second application program.

17. A method for validating data altered in a transaction between software applications, said method comprising:
creating a validation database containing data fields corresponding to data fields of said software applications, said database being independent of said software applications;
updating a particular data field of said validation database in accordance with a transaction conducted between said software applications, said particular data field corresponding to a data field of at least one of said software applications being altered by said transaction; and
comparing said particular data field to said data field of said at least one software application.

18. The method of claim 17, wherein said data fields of said validation database include at least one data field corresponding to both a first software application and a second software application of said software applications.

19. The method of claim. 18, further comprising:
mapping said at least one data field to a corresponding data field of said first software application and to a corresponding data field of said second software application.

20. The method of claim 17, wherein said data fields of said validation database include data fields corresponding to each data field of said software applications.

21. The method of claim 17, wherein said data fields of said validation database include data fields corresponding to a subset of data fields of said software applications.

22. The method of claim 21, wherein data fields of said subset are selected as a function of the likelihood that data stored therein will be altered in a transaction between said software applications.

23. The method of claim 21, wherein data fields of said subset are selected as a function of the likelihood that data stored therein will be anomalous.

24. The method of claim 21, wherein data fields of said subset are selected as a function of the particular transactions operable to alter data stored therein.

25. The method of claim 21, wherein data fields of said subset are selected as a function of the criticality of data stored therein.

26. The method of claim 17, wherein said updating a particular field of said validation database comprises:
monitoring transactions conducted between said software applications using a software application interface.

27. The method of claim 26, wherein said software application interface comprises a plurality of adapters interfacing said software applications.

28. The method of claim 27, further comprising:
providing, by an adapter of said plurality of adapters, an object associated said transaction conducted between said software applications to a process operable to maintain said validation database.

29. The method of claim 17, further comprising:
updating a transaction log to include information with respect to said transaction conducted between said software applications.

30. The method of claim 17, further comprising:
updating a validation log to include information with respect to said comparing said particular data field.

31. The method of claim 17, wherein said particular data field corresponds to a data field of at least another one of said software applications being altered by said transaction, wherein said comparing said particular data field comprises:
comparing said particular data field to said data field of said at least another one of said software applications.

32. The method of claim 17, further comprising:
reporting an anomaly identified through said comparing said particular data field.

33. The method of claim 32, wherein said reporting comprises:
indicating a software application likely to have been the source of said anomaly.

34. The method of claim 32, wherein said reporting comprises:
indicating an adapter of a software interface likely to have been the source of said anomaly.

35. The method of claim 32, wherein said reporting comprises:
indicating a point to which data in said data field of said at least one software application should be rolled back to in order to avoid said anomaly.

36. A system for use in validating data altered in a transaction between software applications, said system comprising:
a validation database containing data fields corresponding to data fields of said software applications, said database being independent of and not accessible to said software applications; and
a validation process in communication with said validation database, said validation process receiving information regarding a transaction between at least a first software application and a second software application of said software applications and altering data of a particular data field of said validation database in accordance with said transaction information.

37. The system of claim 36, further comprising:
a first adapter associated with said first software application; and
a second adapter associated with said second software application, said first and second adapters cooperating to provide an interface between said first and second software applications, at least one of said first and second adapters being in communication with said validation process and providing said transaction information thereto.

38. The system of claim 37, further comprising:
a third adapter associated with at least one of said first and second software applications, said third adapter being in communication with said validation process and facilitating comparison of data of said particular data field of said validation database with data of said at least one of said fist and second software applications.

39. The system of claim 36, further comprising:
a transaction log storing information regarding said transaction between said first and second software applications.

40. The system of claim 39, wherein said information is selected from the group consisting of:
transaction temporal information;
identification of a software application involved in said transaction;
identification of an interface adapter involved in said transaction;
a business process associated with said transaction;
a function associated said transaction; and
performance metrics associated with completion of said transaction.

41. The system of claim 36, further comprising:
a monitoring tool in communication with said validation process, said monitoring tool reporting information with respect to anomalies in data fields of said software applications detected by said validation process using said validation database.

42. The system of claim 36, wherein said data fields of said validation database include at least one data field corresponding to each data field of a database of each said software application.

43. The system of claim 36, wherein said data fields of said validation database include data fields corresponding to selected data fields of databases of said software applications.

44. The system of claim 36, further comprising:
a data field map correlating said data fields of said validation database with one or more corresponding data fields of databases of said software applications.
